(19) United States
(12) Patent Application Publication
(10) Pub. No.: US 2025/0170693 A1
(43) Pub. Date: May 29, 2025

(54) ELASTOMER SELECTING MECHANISM FOR SAFETY SLIDING BAR OF NAIL GUN

(71) Applicant: DE POAN PNEUMATIC CORP., NEW TAIPEI CITY (TW)

(72) Inventors: YING-CHIEH LIU, NEW TAIPEI CITY (TW); CHIN-CHENG CHEN, NEW TAIPEI CITY (TW); HAI-LUN MA, NEW TAIPEI CITY (TW); LU-CHEN STAN CHEN, NEW TAIPEI CITY (TW)

(21) Appl. No.: 18/776,621

(22) Filed: Jul. 18, 2024

(30) Foreign Application Priority Data
Nov. 27, 2023 (TW) 112145810

(51) Int. Cl. B25C 1/00; B25C 1/06

(52) U.S. Cl. CPC B25C 1/008; B25C 1/06

(57) ABSTRACT

An elastomer selecting mechanism for safety sliding bar of a nail gun, comprising defining a falling height of the nail gun and an allowed contraction amount of the elastomer, and determining an ideal elastic coefficient of the elastomer under the condition of the allowed contraction amount based on the gravitational potential energy obtained at the falling height of the nail gun, and then selecting the elastomer based on the ideal elastic coefficient. The elastomer has a maximum elastic coefficient to avoid permanent deformation of the safety sliding bar and a minimum elastic coefficient to maintain the touching and pressing feel of the safety sliding bar. The ideal elastic coefficient is limited by the maximum elastic coefficient and the minimum elastic coefficient to ensure the touching and pressing feel of the safety sliding bar and to avoid permanent deformation when the nail gun is subject to falling impact.

### BACKGROUND OF INVENTION

### 1. Field of the Invention

The present invention relates to the safety sliding bar slidably configured on a nail gun, and the elastomer configured on one end of the sliding travel distance of the safety sliding bar to elastically stop the safety sliding bar. The present invention specifically focuses on avoiding the problem of permanent deformation of the safety sliding bar, and provides an elastomer selecting mechanism for the safety sliding bar of a nail gun.

### 2. Description of Related Art

A nail gun is a hand tool for nailing and fixing an object. Based on the power used to drive the nailing component, nail guns can be roughly divided into two types: pneumatic nail guns and electric nail guns.

Conventionally, the gun body of a nail gun comprises: a driver, a striker, a nail cartridge, a trigger, and a safety sliding bar. Specifically, the driver of a pneumatic nail gun roughly comprises a piston and a cylinder, the piston is integrated with the striker, and the cylinder inside receives high-pressure air action of pressure differences generated, as to drive the piston to produce a reciprocating nail action.

The safety sliding bar is used in consideration of safety during nailing operations. It is located between the trigger and the pneumatic or electric power supply of the driver, and is used to control two operation modes: sequential actuation and contact actuation. Specifically, in the sequential actuation mode, the user must firstly press the safety sliding bar upon the work piece to be nailed, and then press the trigger to actuate the driver, so as to drive the striker to shoot one nail after another. In the contact actuation mode, the user firstly presses and holds the trigger, and continuously uses the safety sliding bar to knock the work piece, so as to actuate the driver to continuously drive the striker for continuous nailing.

Moreover, the safety sliding bar can be made of one or more link assemblies and is slidably configured on the gun body along a nailing axial direction of the striker. In addition, the safety sliding bar is usually configured with a nailing depth adjuster, a coil spring, and a buffering elastomer. Furthermore, in two kinds of operation modes, the safety sliding bar respectively has a bottom position and a limiting point on the two ends in the nailing axial direction. The elastomer will be configured at the limiting point. When the user presses or butts the safety sliding bar upon the work piece to be nailed, the safety sliding bar will slide along the nailing axial direction to move from the bottom position to the limiting point and press the elastomer. Now, the elastomer will provide a buffering elastic force to stop the safety sliding bar at the limiting point.

In addition, in general use, a user holding or hanging a nail gun may neglect and cause the nail gun to drop onto the ground, and the safety sliding bar will be subjected to impact from the gravitational potential impact energy. Now, the safety sliding bar will slide along the nailing axial direction to move from the bottom position to the limiting point to press the elastomer, and transmits the counter force generated by the gravitational potential energy to impact the elastomer, thereby leading to poor durability or breakage of the elastomer, or even causing permanent deformation of the safety sliding bar to prevent it from normal sliding.

The gravitational potential energy generated when the nail gun is falling to the ground is determined by the height and weight of the nail gun, and the weight is different between electric and pneumatic nail guns. Furthermore, the gun body of a common electric nail gun is configured with heavy components including power flywheel assembly, power clutch assembly, and batteries, whereas the gun body of a common pneumatic nail gun is configured with lighter components mainly including the driver composed the piston and the cylinder. In contrast, an electric nail gun is much heavier than a pneumatic nail gun. Therefore, the gravitational potential energy generated when an electric nail gun is falling to the ground will be much higher than a pneumatic nail gun. In other words, when a nail gun is falling to the ground, the safety sliding bar and the elastomer configured in an electric nail gun will receive much greater impact from the gravitational potential energy than the safety sliding bar and elastomer configured in a pneumatic nail gun. However, currently there is no effective technical strategy to address this problem. Therefore, the safety sliding bar and elastomer configured in the existing nail guns may easily be damaged due to excessive gravitational potential energy when the nail gun falls to the ground accidentally from a specific height. This problem must be solved.

Moreover, in the current nail gun manufacturing technology, the selection of the above elastomer has not considered the following issue: when an elastomer can provide a huge elastic force, the safety sliding bar will easily be permanently deformed. When the elastomer can only provide a small elastic force, the user will have poor hand feel when pressing or butting the safety sliding bar upon the work piece, so that loses the intention of using the nail gun. In other words, the prior art has not provided effective solutions to all of the above-mentioned problems.

### DESCRIPTION OF INVENTION

The present invention aims to improve the conventional nail guns wherein the elastomer is selected only in consideration of providing a buffering elastic force to stop the safety sliding bar at the limiting point, without considering the alleviation of the impact of gravitational potential energy transmitted from the safety sliding bar to the elastomer when the nail gun falls to the ground accidentally, which can easily permanently deform the front guiding bar of the safety sliding bar to prevent it from further sliding and pressing, or damage the elastomer. The present invention provides an improvement strategy to enhance the durability of the elastomer. the elastomer will provide a buffering elastic force to stop the safety sliding bar at the limiting point

Therefore, the present invention provides an selecting mechanism for the elastomer of a nail gun (including electric and pneumatic nail guns) to alleviate the falling impact to the safety sliding bar, so that nail gun developers can rely on the mechanism when selecting an elastomer with preferred elastic coefficient to alleviate impact of gravitational potential energy to the safety sliding bar while maintaining good hand feel, and to effectively avoid permanent deformation of the safety sliding bar.

In a preferred embodiment, the elastomer selecting mechanism comprises: defining a falling height of the nail gun and an allowed contraction amount of the elastomer; obtaining a gravitational potential energy of the nail gun at the falling height based on a weight of the nail gun, and determining an ideal elastic coefficient of the elastomer under the condition of the allowed contraction amount based on the gravitational potential energy, and then selecting an optimal elastomer based on the ideal elastic coefficient. Specifically, the elastomer has a maximum elastic coefficient to avoid permanent deformation of the safety sliding bar, the elastomer also has a minimum elastic coefficient to maintain touching and pressing feel of the safety sliding bar, and the ideal elastic coefficient of the optimal elastomer is limited by the maximum elastic coefficient and the minimum elastic coefficient.

In further implementation:

The gravitational potential energy is obtained via Eq. (1):

$${E}_{p} = mg h . \qquad Eq . ( 1 )$$

The maximum elastic coefficient is obtained via Eq. (2), and the minimum elastic coefficient is obtained via Eq. (3):

$${k}_{max} = \frac{{F}_{1}}{{x}_{1}} ; \qquad Eq . ( 2 )$$

$${k}_{min} = \frac{{F}_{2}}{{x}_{2}} . \qquad Eq . ( 3 )$$

The limitation of the ideal elastic coefficient is represented by Eq. (4):

$${k}_{max} \geq k \geq {k}_{min} . \qquad Eq . ( 4 )$$

In Eq. (1) to Eq. (4), mg is the weight of the nail gun, h is the falling height of the nail gun, Eₚ is the gravitational potential energy of the nail gun at the falling height, kₘₐₓ is the maximum elastic coefficient of the elastomer, F₁ is the maximum impact received by the safety sliding bar upon permanent deformation, kₘᵢₙ is the minimum elastic coefficient of the elastomer, F₂ is the minimum pressing force to maintain the touching and pressing feel of the safety sliding bar, x₁ is the allowed contraction amount of the elastomer to bear the impact of safety sliding bar when the nail gun falls, x₂ is the allowed contraction amount of the elastomer when the safety sliding bar presses upon the surface of the work piece, and k is the ideal elastic coefficient of the optimal elastomer.

Based on the above implementation, the present invention provides double advantages: ensuring contacting and pressing comfort of the safety sliding bar and avoiding permanent deformation of the safety sliding bar by alleviating the falling impact when the nail gun is dropped by accident. The invention helps to avoid damage to the elastomer and to enhance the durability of the elastomer. The implementation methods and technical effects of the invention will be described in detail below with reference to the accompanying figures.

### BRIEF DESCRIPTION OF THE DRAWINGS

FIG. 1 is a front view of an electric nail gun taken as an example by the present invention.

FIG. 2 is a configuration view of the safety sliding bar and elastomer in FIG. 1.

FIG. 3(a) and FIG. 3(b) are sequential action views of the safety sliding bar in FIG. 2 before and after receiving the impact.

FIG. 4 is a computer simulation view of the maximum impact that the front section sliding bar of the safety sliding bar shown in FIG. 3 can withstand.

FIG. 5(a) and FIG. 5(b) are computer simulation views of the sequential deformation of the front section sliding bar shown in FIG. 4 before and after receiving the impact.

### DETAILED DESCRIPTION OF THE INVENTION

Because an electric nail gun is relatively heavier than an ordinary pneumatic nail gun, the present invention will take an electric nail gun as an example to explain the selecting mechanism of the elastomer. However, this does not mean that the implementation of the present invention disclosed below is only for application in an electric nail gun. In other words, the present invention can be applied in any electric or pneumatic nail guns with weight, to alleviate the impact on the safety sliding bar when the nail gun is dropped by accident.

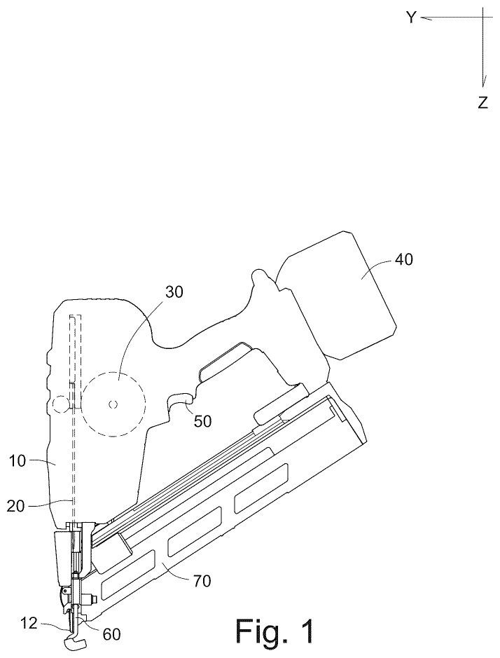

Firstly, referring to FIG. 1, the present invention uses a handheld electric nail gun as an example of implementation. As disclosed, the electric nail gun has a gun body 10, the gun body 10 is formed with a shooting nozzle 12 to shoot the nail, and inside the chamber, the configurations are as follow: along a nailing direction (Z axial direction marked in the figure), a striker 20 is configured to move to and fro to shoot the nail, a power flywheel assembly 30 to drive the striker 20 to generate linear nailing momentum, a battery 40 to provide electric power to the power flywheel assembly 30, a trigger 50 for the user to press by finger to control the nailing operation, a safety sliding bar 60 to work with the trigger 50 to control two safe nailing modes, and a nail cartridge 70 to supply nails.

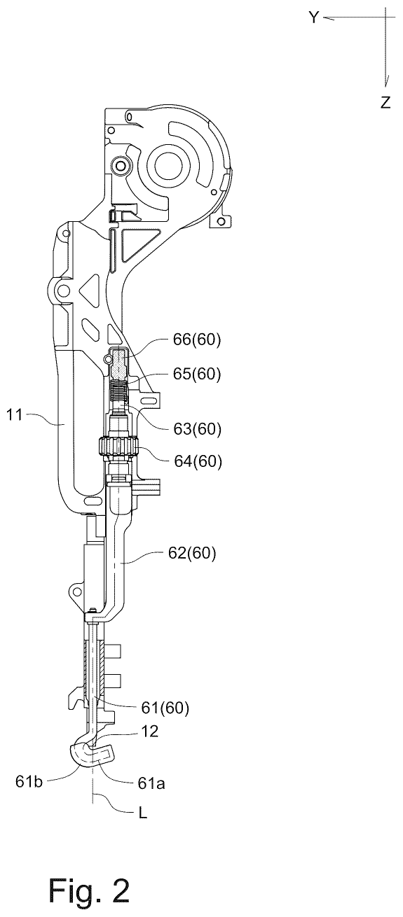

As disclosed in FIG. 2, the gun body 10 shown in FIG. 1 is also integrally formed with a frame 11, which is considered as a fixing end. The safety sliding bar 60 is configured inside the frame 11, and the safety sliding bar 60 comprises a front section sliding bar 61 slidably fitted inside the sliding chute provided by the frame 11, a middle section guiding bar 62 connected on the top end of the front section sliding bar 61, and a rear section push bar 63 connected on the tip end of the middle section guiding bar 62. Specifically, the tip end of the front section sliding bar 61 has a front end butting part 61a. The periphery of the front end butting part 61a is covered by a protective soft cushion 61b. The middle section guiding bar 62 and the rear section push bar 63 are connected through a nailing depth adjuster 64, and the rear section push bar 63 is sleeved with a coil compression spring 65 for the nailing depth adjuster 64 to adjust the nailing depth. In addition, at a position near the rear section push bar 63, the frame 11 is also configured with an elastomer 66 to support and receive pressure from the rear section push bar 63.

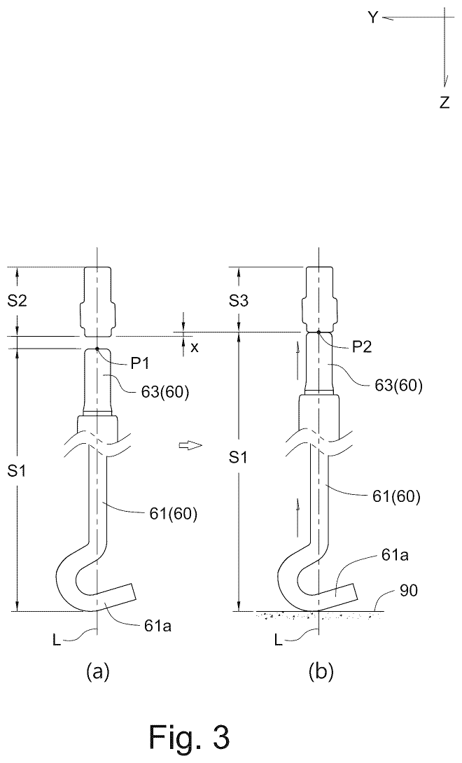

Based on the above configuration, in normal nailing operation, when the user is holding the nail gun 10 shown in FIG. 1 and still has not butt the front end butting part 61a of the front section sliding bar 61 upon the surface of the work piece [as shown in FIG. 3(a), omitting the soft cushion 61b], the tip end of the rear section push bar 63 of the safety sliding bar 60 is located at a bottom position P1 not contacting the elastomer 66. Then, when the user abuts the front end butting part 61a of the front section sliding bar 61 upon the surface of the work piece 90 to start nailing [as shown in FIG. 3(b), omitting the soft cushion 61b], the safety sliding bar 60 will slide upward along the nailing axial direction (Z axial direction marked in the figure) (upward direction in the figure), so that the tip end of the rear section push bar 63 moves from the bottom position P1 shown in FIG. 3(a) to a limiting point P2 shown in FIG. 3(b). During the course, the elastomer 66 is pressed by the tip end of the rear section push bar 63 to generate an allowed contraction amount x, to buffer and protect the safety sliding bar 60. Meanwhile, the allowed contraction amount x of the elastomer 66 also provides a feedback of a pressing or butting feel. Then, when the user lifts up the nail gun 10 and the front end butting part 61a leaves the surface of the work piece 90, the safety sliding bar 60 relies on the elastic recovering force provided by the coil compression spring 65 and the elastomer 66, the front end butting part 61a of the front section sliding bar 61 will slide from the limiting point P2 shown in FIG. 3(b) back to the bottom position P1 shown in FIG. 3(a).

In addition, it is to be noted that, the front section sliding bar 61, the middle section guiding bar 62, the nailing depth adjuster 64, the coil compression spring 65, and the rear section push bar 63 are distributed along an assembly axial line L to form an integral body having a specific length S1. Specifically, the elastomer 66 is elastically connected with the rear section push bar 63 through the coil compression spring 65 along the assembly axial line, and the elastomer 66 has a height before pressing S2. In case of an accidental drop, the front section sliding bar 61 of the safety sliding bar 60 will be subjected to the impact from the surface of the work piece, the ground, or other resisting surfaces, and the impact will result in a counter force along the assembly axial line L toward the nailing axial direction (Z axial direction marked in the figure) to act on the coil compression spring 65 and the elastomer 66. Virtually, the assembly axial line L converges the impact into a positive counter force along the nailing axial direction (Z axial direction marked in the figure). However, as the elasticity of the soft cushion 61b and the coil compression spring 65 is too small, the counter force is mainly alleviated by the elastomer 66. Upon receiving the impact from the counter force, the elastomer 66 will immediately contract from the height before pressing S2 to a height after pressing S3. Specifically, the sum of height after pressing S3 and allowed contraction amount x equals height before pressing S2 (i.e., S2=S3+x).

Based on the technical prospect of the above nail gun, the present invention provides a selecting mechanism for the elastomer 66 to alleviate the gravitational potential energy generated when the nail gun falls to the ground accidentally, so as to avoid permanent deformation of the front section sliding bar 61 of the safety sliding bar 60, and its front end butting part 61a.

The selecting mechanism of the elastomer 66 according to the present invention comprises the following steps:

### 1. Obtaining the Gravitational Potential Energy

When an electric nail gun (hereinafter referred to as nail gun), the one shown in FIG. 1 being an example, falls to the ground, the surface of the work piece, or any other resisting surface from a specific falling height, the gravitational potential energy generated can be obtained via the following Eq. (1):

$${E}_{p} = mg h \qquad Eq . ( 1 )$$

In Eq. (1), Eₚ is the gravitational potential energy of the nail gun, mg is the weight generated by the mass of the nail gun, h is the distance from the nail gun to the ground (i.e., falling height).

The above falling height h can be defined based on the user's habit in using the nail gun, and be considered as the allowed falling height of the nail gun. For instance, when the weight mg=4.5 kgf, falling height h=1 m, according to Eq. (1), when the nail gun falls to the ground, the generated gravitational potential energy Eₚ=44.145 J (Joule).

### 2. Obtaining the Maximum Elastic Coefficient of the Elastomer

The elastomer 66 can be made by viscoelastic polymers, which practically include rubber, thermosetting polymers and thermoplastic polymers. The elastomer 66 is used to alleviate the gravitational potential energy generated when the nail gun falls to the ground, and to avoid permanent deformation of the safety sliding bar 60 (particularly the front section sliding bar 61 and its front end butting part 61a). Under this condition, the present invention focuses on the consideration that the elastomer 66 has a maximum elastic coefficient to avoid permanent deformation of the safety sliding bar 60 (particularly the front section sliding bar 61 and its front end butting part 61a), which can be obtained via the following Eq. (2):

$${k}_{max} = \frac{{F}_{1}}{{x}_{1}} \qquad Eq . ( 2 )$$

In Eq. (2), kₘₐₓ is the maximum elastic coefficient of the elastomer, F₁ is the maximum impact received by the safety sliding bar upon permanent deformation, x₁ is the allowed contraction amount of the elastomer to bear the impact of safety sliding bar when the nail gun falls.

Generally speaking, the front section sliding bar 61 can be made of spring steel. In Table 1, the tensile strengths of SW-C spring steel wire materials suitable for making the front section sliding bar 61 are listed based on various diameters. Specifically, SW-C spring steel wire with diameter of 4.0 mm is used to make the front section sliding bar 61. Its tensile strength ranges from 1570 to 1770 MPa. If this upper limit is exceeded, permanent deformation may occur to the spring steel wire.

TABLE 1
Tensile Strengths of SW-C Spring Steel (Source: linsgroup.com)

| | Steel wire diameter | SW-C tensile strength |
|---|---|---|
| Selection | (mm) | (MPa) |
| | 1.6 | 1810~2060 |
| | 2.0 | 1720~1960 |
| | 2.6 | 1670~1910 |
| | 3.2 | 1570~1810 |
| V | 4.0 | 1570~1770 |
| | 5.0 | 1520~1720 |
| | 6.0 | 1420~1620 |

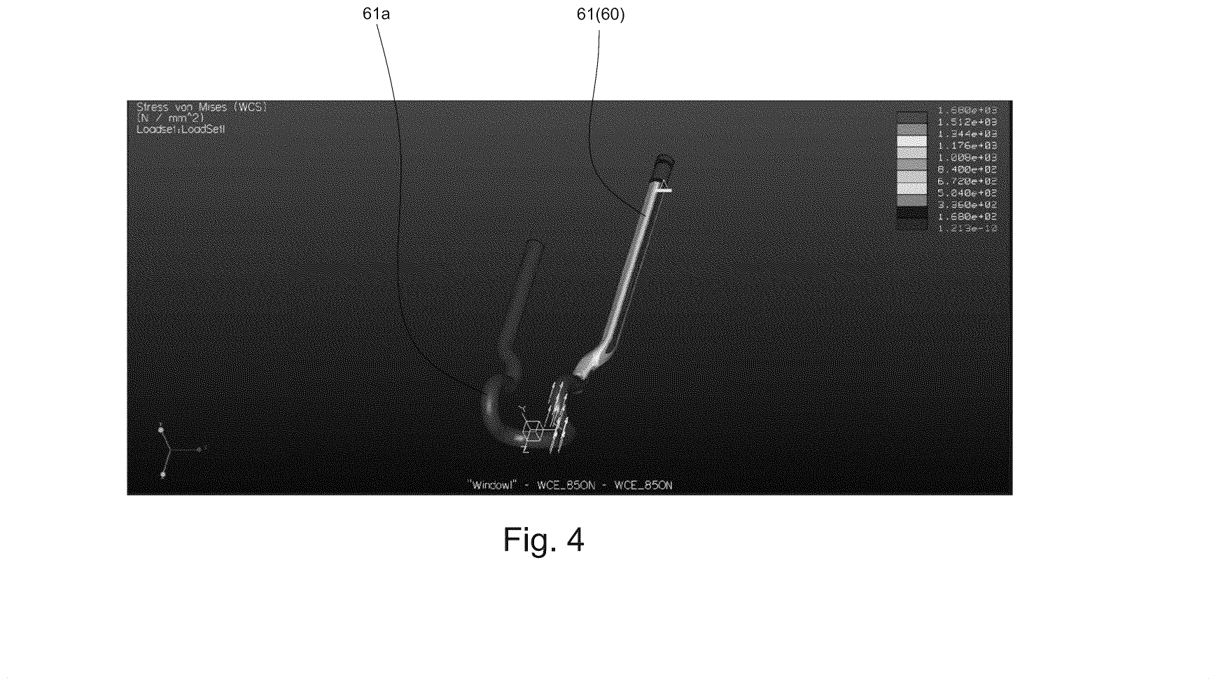

FIG. 4 shows the stress changes that occurs when the front section sliding bar 61 is impacted, that is select the material (steel wire diameter 4.0 of SW-C Spring Steel) in Table 1 to make the front section sliding bar 61 and known its Young's Modulus and Poisson's Ratio for importing FEA, so as to calculate the stress change produced by the front section sliding bar 61, in order to compare with the tensile strength (1570˜1770 MPa) of the checked material. Further, the simulation obtains the pressure change that the front section sliding bar 61 (the part of the closer to light color in FIG. 4 the greater the pressure). According to this, the maximum impact (F₁≤850N) that the safety sliding bar 60 can instantly withstand of permanent deformation. Under this condition, the yield stress of the SW-C spring steel wire with diameter of diameter 4.0 mm will not be exceeded, so that permanent deformation of the front end butting part 61a will not happen.

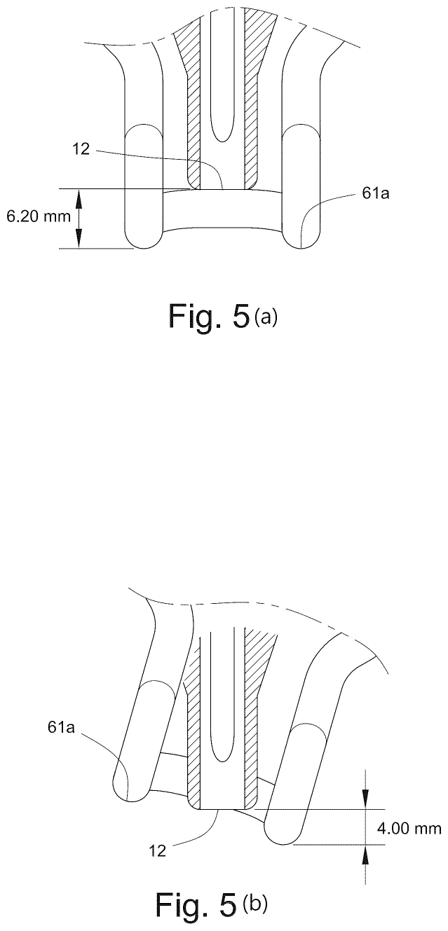

Now please refer to FIG. 5(a) and FIG. 5(b). Specifically, according to FIG. 5(a), when the rear section push bar 63 shown in FIG. 4 contacts the end surface of the elastomer 66, the distance between the front end butting part 61a of the front section sliding bar 61 and the shooting nozzle 12 is 6.20 mm. Then, according to FIG. 5(b), when the front section sliding bar 61 is subject to maximum impact F₁=850N, the distance between the front end butting part 61a and the shooting nozzle 12 is contracted to 4.00 mm. In other words, before and after the front end butting part 61a is subject to impact, according to calculation by FEA, the maximum deformation amount of front end butting part 61a y=5 mm. After linear simplification, the allowed contraction amount of the elastomer 66 x=2.2 mm (6.20 mm-4.00 mm). Based on this, if we substitute the above F₁=850 N and x=2.2 mm into Eq. (2), we can obtain the maximum elastic coefficient of the elastomer 66 kₘₐₓ=40 kgf/mm.

### 3. Obtaining Minimum Elastic Coefficient of the Elastomer

In normal nailing operation of the nail gun, when the user presses or butts the front end butting part 61a of the safety sliding bar 60 upon the surface of the work piece, the pressing or butting feel transmitted from the hand to the brain will influence the user's confidence in the two operation modes of sequential actuation and contact actuation. Therefore, anti-dropping design must also consider the hand feel of the user when pressing the front end butting part 61a upon the work piece 90 in normal operation. Through long duration tests, the inventor defined a minimum pressing force F₂=450 N to maintain comfortable touching and pressing feel of the user, and postulated that touching and pressing comfort can still be obtained under the condition that the allowed contraction amount of the elastomer x₂ 2.0 mm when the safety sliding bar presses upon the surface of the work piece. By substituting this value into Eq. (3), we can obtain the minimum elastic coefficient of the elastomer kₘᵢₙ=26 kgf/mm:

$${k}_{min} = \frac{{F}_{2}}{{x}_{2}} \qquad Eq . ( 3 )$$

### 4. Determining an Ideal Elastic Coefficient of the Elastomer

The ideal elastic coefficient k of the elastomer 66 must be limited by the maximum elastic coefficient and the minimum elastic coefficient to avoid permanent deformation by alleviating the falling impact while ensuring comfortable hand feel when pressing the safety sliding bar 60. Therefore, the ideal elastic coefficient k of the elastomer 66 can be represented by the following Eq. (4):

$${k}_{max} \geq k \geq {k}_{min} . \qquad Eq . ( 4 )$$

As seen above, the maximum elastic coefficient of the elastomer kₘₐₓ=40 kgf/mm, and the minimum elastic coefficient of the elastomer kₘᵢₙ=26 kgf/mm. By substituting them into Eq. (4), we obtain: 40 kgf/mm≤k≤26 kgf/mm. Then, based on the range of the ideal elastic coefficient k, an appropriate of the optimal elastomer can be selected.

Although the invention has been explained in relation to its preferred embodiment, it is to be understood that many other possible modifications and variations can be made without departing from the spirit and scope of the invention as hereinafter claimed.

1. An elastomer selecting mechanism for safety sliding bar of a nail gun, to select an ideal elastomer to alleviate the impact received by the safety sliding bar when the nail gun falls to the ground by accident, said elastomer selecting mechanism comprising:
defining a falling height of the nail gun and an allowed contraction amount of the elastomer;
obtaining a gravitational potential energy of the nail gun at the falling height based on a weight of the nail gun, and determining an ideal elastic coefficient of the elastomer under the condition of the allowed contraction amount based on the gravitational potential energy, and then selecting an optimal elastomer based on the ideal elastic coefficient;
specifically, the elastomer has a maximum elastic coefficient to avoid permanent deformation of the safety sliding bar, the elastomer also has a minimum elastic coefficient to maintain touching and pressing feel of the safety sliding bar, and the ideal elastic coefficient of the optimal elastomer is limited by the maximum elastic coefficient and the minimum elastic coefficient.

2. The elastomer selecting mechanism for safety sliding bar of a nail gun defined in claim 1, wherein the gravitational potential energy is obtained via Eq. (1):
$${E}_{p} = mg h \qquad Eq . ( 1 )$$
specifically, mg is the weight of the nail gun, h is the falling height of the nail gun, Eₚ is the gravitational potential energy of the nail gun at the falling height.

3. The elastomer selecting mechanism for safety sliding bar of a nail gun defined in claim 2, wherein the maximum elastic coefficient is obtained via Eq. (2), and the minimum elastic coefficient is obtained via Eq. (3):
$${k}_{max} = \frac{{F}_{1}}{{x}_{1}} \qquad Eq . ( 2 )$$
$${k}_{min} = \frac{{F}_{2}}{{x}_{2}} \qquad Eq . ( 3 )$$
specifically, kₘₐₓ is the maximum elastic coefficient of the elastomer, F₁ is the maximum impact received by the safety sliding bar upon permanent deformation, kₘᵢₙ is the minimum elastic coefficient of the elastomer, F₂ is the minimum pressing force to maintain the touching and pressing feel of the safety sliding bar, x₁ is the allowed contraction amount of the elastomer to bear the impact of safety sliding bar when the nail gun falls, and x₂ is the allowed contraction amount of the elastomer when the safety sliding bar presses upon the surface of the work piece.

4. The elastomer selecting mechanism for safety sliding bar of a nail gun defined in claim 3, wherein
$${k}_{max} = 40 \frac{kg f}{mm} ,$$
and kₘᵢₙ=26 kgf/mm.

5. The elastomer selecting mechanism for safety sliding bar of a nail gun defined in claim 3, wherein the limitation of the ideal elastic coefficient is represented by the following in Eq. (4):
$${k}_{max} \geq k \geq {k}_{min} \qquad Eq . ( 4 )$$
specifically, k is the ideal elastic coefficient of the optimal elastomer.

6. The elastomer selecting mechanism for safety sliding bar of a nail gun defined in claim 5, wherein
$${k}_{max} = 40 \frac{kg f}{m m} ,$$
and kₘᵢₙ=26 kgf/mm.

7. The elastomer selecting mechanism for safety sliding bar of a nail gun defined in claim 1, wherein said nail gun is an electric nail gun.
